(19) United States
(12) Patent Application Publication
(10) Pub. No.: US 2025/0273801 A1
(43) Pub. Date: Aug. 28, 2025

(54) SYSTEMS FOR A VEHICLE BATTERY PACK

(71) Applicant: Ford Global Technologies, LLC, Dearborn, MI (US)

(72) Inventors: Larry WANG, Nanjing (CN); Shiwu HAO, Nanjing (CN); Fei GAO, Hefei (CN)

(21) Appl. No.: 19/045,467

(22) Filed: Feb. 4, 2025

(30) Foreign Application Priority Data
Feb. 22, 2024 (CN) 202420333745.9

(51) Int. Cl. H01M 50/291; H01M 10/613; H01M 10/6556; H01M 10/658; H01M 50/249; H01M 50/293; H01M 50/367; H01M 50/569

(52) U.S. Cl. CPC H01M 50/291; H01M 10/613; H01M 10/6556; H01M 10/658; H01M 50/249; H01M 50/293; H01M 50/367; H01M 50/569; H01M 2220/20

(57) ABSTRACT

The present disclosure relates to a battery pack. The battery pack includes a first array including a plurality of first battery cells arranged side by side, a second array including multiple second battery cells arranged side by side, a plurality of partition plates located between the first array and the second array and configured to electrically isolate the first array from the second array, and a plurality of support members located between the first array and the second array, wherein the second array is supported against the first array via the plurality of support members.

### CROSS REFERENCE TO RELATED APPLICATION

The present application claims priority to Chinese Patent Application No. 202420333745.9 filed on Feb. 22, 2024. The entire contents of the above-listed application is hereby incorporated by reference for all purposes.

### FIELD

The present description relates generally to vehicle battery pack.

### BACKGROUND/SUMMARY

The increasing demand for driving range and the increasing number of electrical devices in modern motor vehicles can lead to an overall increase in power demand, resulting in a larger space occupied by vehicle battery packs and a more complex internal structure.

In one example, the issues described above may be addressed by a battery pack including a first array including a plurality of first battery cells arranged side by side, a second array including multiple second battery cells arranged side by side, a plurality of partition plates located between the first array and the second array and configured to electrically isolate the first array from the second array, and a plurality of support members located between the first array and the second array, wherein the second array is supported against the first array via the plurality of support members.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of a vehicle including a vehicle battery pack according to one or more embodiments of the present disclosure;

FIG. 2 shows an exploded view of the vehicle battery pack according to one or more embodiments of the present disclosure;

FIG. 3 shows a partial cross-sectional view of the vehicle battery pack according to one or more embodiments of the present disclosure in one direction;

FIG. 4 shows a partial cross-sectional view of the vehicle battery pack according to one or more embodiments of the present disclosure in another direction;

FIG. 5 shows an overall cross-sectional view of the vehicle battery pack according to one or more embodiments of the present disclosure along a transverse direction of the vehicle;

FIG. 6 shows a partial cross-sectional view of the vehicle battery pack according to one or more embodiments of the present disclosure in yet another direction;

FIG. 7 shows a partial perspective view of the vehicle battery pack according to one or more embodiments of the present disclosure, in which a partition plate and support members are shown in an assembled state;

FIG. 8 shows a partial enlarged view of the vehicle battery pack according to one or more embodiments of the present disclosure, in which the partition plate and the support members are shown in the assembled state in an enlarged form;

FIG. 9 shows an exploded view of the partition plate and the support members of the vehicle battery pack according to one or more embodiments of the present disclosure;

FIG. 10 shows a perspective view of the partition plate and the support members of the vehicle battery pack according to one or more embodiments of the present disclosure in a combined state;

FIG. 11 shows an enlarged view of the partition plate and the support members of the vehicle battery pack according to one or more embodiments of the present disclosure in the combined state;

FIG. 12 shows a partial cross-sectional view of the vehicle battery pack according to one or more embodiments of the present disclosure in yet another direction; and

FIG. 13 shows a partial perspective view of another part of the vehicle battery pack according to one or more embodiments of the present disclosure.

### DETAILED DESCRIPTION

The present disclosure summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this application.

According to an aspect of the present disclosure, there is provided a vehicle battery pack including a first array including multiple first battery cells arranged side by side, a second array including multiple second battery cells arranged side by side and located above the first array, a partition plate located between the first array and the second array and electrically isolating the first array and the second array; and support members located between the first array and the second array, wherein the second array is supported on the first array by the support member.

According to an embodiment of the present disclosure, the partition plate is connected to the support members through connecting structures.

According to an embodiment of the present disclosure, the connecting structure comprises a groove and a protrusion that match each other in shape.

According to an embodiment of the present disclosure, the support member extends along a first direction and is supported on critical portions of adjacent first battery cells extending along the first direction.

According to an embodiment of the present disclosure, the vehicle battery pack further comprises a thermal insulation plate, openings corresponding to cell exhaust ports of the first battery cells are provided on the partition plate, and the thermal insulation plate and the partition plate jointly enclose an exhaust channel connected to the openings.

According to an embodiment of the present disclosure, the vehicle battery pack further comprises an exhaust valve corresponding to an end of the exhaust channel.

According to an embodiment of the present disclosure, a stopper is provided on the groove or protrusion to limit relative installation position of the two.

According to an embodiment of the present disclosure, the vehicle battery pack further comprises a flexible sampling plate for collecting information of each battery cell, and openings for the flexible sampling plate to sample the first battery cells is provided on the partition plate.

According to an embodiment of the present disclosure, the vehicle battery pack further comprises a battery tray and a cooling plate, the battery tray has a tray reinforcement groove that is concave downwards, and the cooling plate has a coolant channel that protrudes downwards and is located inside the battery tray reinforcement groove.

According to another aspect of the present disclosure, there is provided a vehicle comprising the vehicle battery pack as described in any of the above embodiments.

The present disclosure summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this application.

The inventors of the present application recognize that there is a demand for a vehicle battery pack and a corresponding vehicle which can further affect space utilization efficiency, simplify overall structure of the battery packs while reducing production resources, thereby addressing user satisfaction.

According to an aspect of the present disclosure, there is provided a vehicle battery pack including a first array including multiple first battery cells arranged side by side, a second array including multiple second battery cells arranged side by side and located above the first array, a partition plate located between the first array and the second array and electrically isolating the first array and the second array, and support members located between the first array and the second array, wherein the second array is supported on the first array by the support member.

There may be benefits in such a vehicle battery pack that can further better space utilization efficiency and simplify overall structure, and provide higher power based on limited space while reducing production resources.

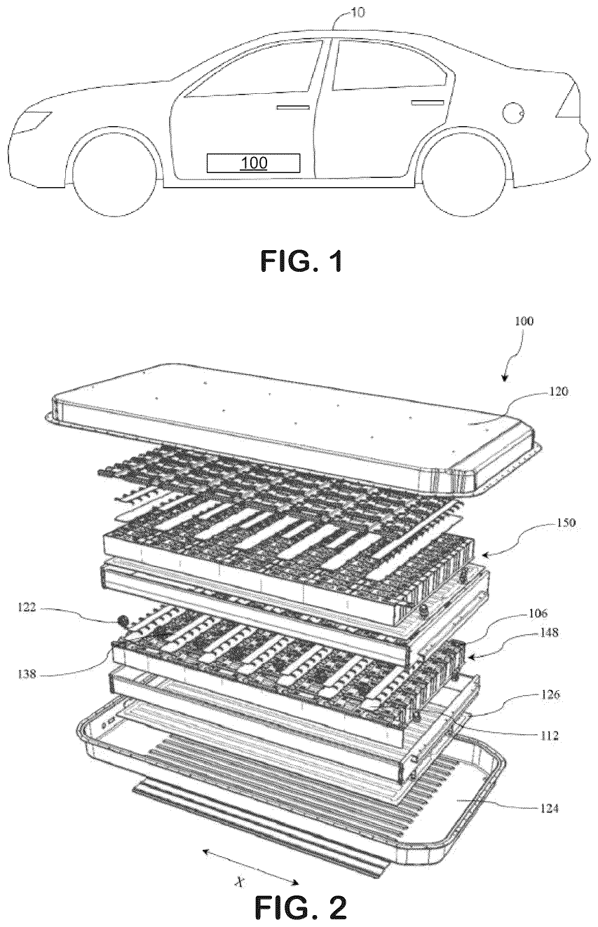

Turning now to FIG. 1, it shows a schematic diagram of a vehicle 10 including a battery pack 100 according to one or more embodiments of the present disclosure. It should be understood that in the context of the present disclosure, the vehicle 10 implementing the present disclosure can refer to a plurality of types of transportation including the vehicle battery pack, such as but not limited to, internal combustion engine (ICE) vehicles, electric vehicles (such as plug-in hybrid electric vehicles (PHEVs), fully hybrid electric vehicles (FHEVs), mild hybrid electric vehicles (MHEVs) or battery electric vehicles (BEVs), and ships, aircrafts, etc. The vehicle 10 may include components related to mobility, such as an engine, an electric motor, a transmission, a suspension, a drive shaft, and/or wheels. The vehicle 10 may be non-autonomous, semi-autonomous (for example, some conventional motion functions are controlled independently by the vehicle) or fully autonomous (for example, motion functions are controlled independently by the vehicle without direct input from user).

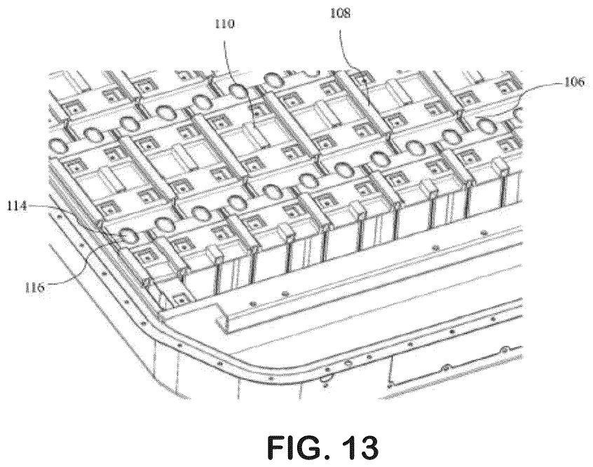

An aspect of the present disclosure provides a vehicle battery pack 100. Referring to FIGS. 2 to 13, which may be described in tandem herein, the battery pack 100 includes a first array 148, a second array 150, a partition plate 106, and a plurality of support members 108. The first array 148 includes multiple first battery cells 102 arranged side by side, the second array 150 includes multiple second battery cells 104 arranged side by side, and the second array 150 is located above the first array 148. The partition plate 106 is located between the first array 148 and the second array 150 and is used to electrically isolate the first array 148 from the second array 150. The support members 108 are located between the first array 148 and the second array 150, and the second array 150 is supported on the first array 148 through the support members 108.

Those skilled in the art should understand that, in the context of the present disclosure, directional expressions such as “transverse”, “longitudinal”, “vertical”, “upper”, “lower”, “front”, “rear”, “lateral”, “top”, and “bottom” mentioned above and below are related to the battery pack in its installed state and the vehicle to which the battery pack is installed. For example, “longitudinal” may generally correspond to the longitudinal direction of the vehicle 10 to which the battery pack 100 is installed, or the front and rear direction of the vehicle; “transverse” may generally correspond to the lateral direction of the vehicle 10, or the left and right directions of the vehicle; “upper” may generally correspond to the vertical upward direction of the vehicle 10; “lower” may generally corresponds to the vertical downward direction of the vehicle 10, and so on. Said another way, a first object lower than a second object may be below the object relative to a direction of gravity. The expression “the second array 150 is supported on the first array 148 through the support members 108” referred to in this disclosure is defined in that at least a portion or all of the weight of the second array 150 is directly supported on the first array 148 itself through the support members 108. In addition, in the illustrated example, the second array 150 located above may cover all of the first array 148 located below, that is, the battery pack 100 has a complete double-layer structure; and in other possible examples, the second array 150 located above may only cover a portion of the first array 148 located below, that is, the battery pack 100 has a partial double-layer structure.

In the scheme of the present disclosure, the second array 150 is directly supported on the first array 148 through the support members 108 and electrically isolated from the first array 148 via the partition plate 106. In the battery pack 100, the demand for additional support structures for the upper array (e.g., the second array 150) is simplified, and the space between the first array 148 and the second array 150 is compressed, making the overall structure more compact, bettering energy density of the battery, and further enhancing space utilization efficiency, thereby impacting user satisfaction.

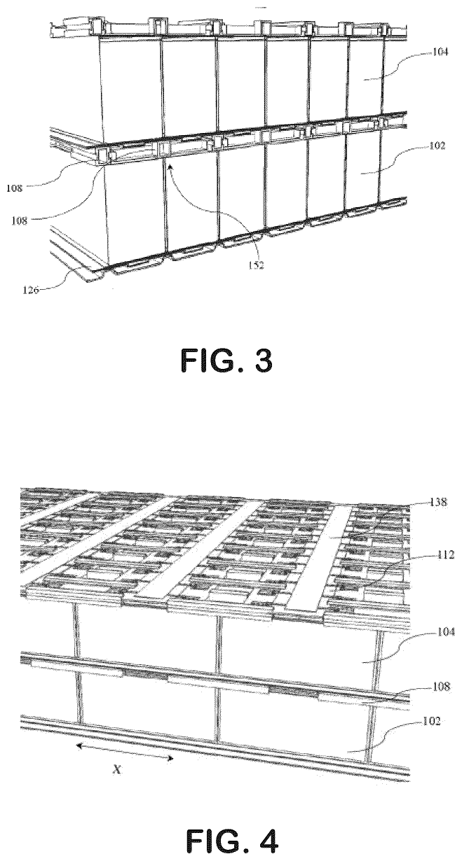

Referring to FIGS. 3 and 4, in some embodiments of the present disclosure, the support member of the plurality of support members 108 extends along a first direction X and is directly supported on critical portions 152 of the adjacent first battery cells 102 extending along the first direction X. In the embodiment shown in FIG. 4, the first direction X is the longitudinal direction of the vehicle; and in other possible embodiments, the first direction X can also be the transverse direction of the vehicle or other possible directions. The critical portion 152 can be understood as a portion that extends from an edge of the battery cell to the inside, ranging from one fourth to one tenth, which is only an example and not a limitation. Due to the better vertical support provided by the vertical part of the battery cell casing, directly supporting each support member on the critical portions 152 can provide more stable support for the second array 150 located above. In the illustrated embodiment, the first battery cells 102 and the second battery cells 104 can be rectangular lithium-ion battery cells or prismatic lithium-ion battery cells. However, within the scope of this disclosure, battery cells with other geometric shapes (such as cylindrical, pouch shaped, etc.), other chemical substances (nickel metal hydride, lead-acid, etc.), or a combination of both can be used instead.

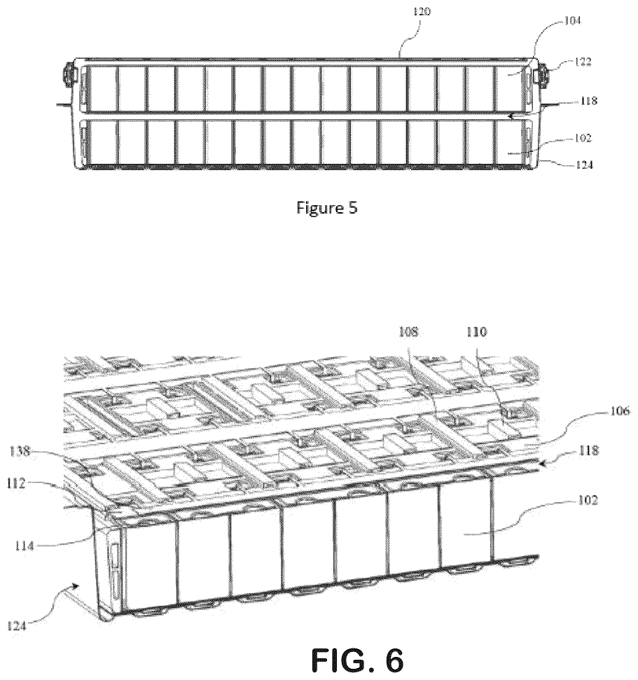

Referring to FIGS. 5 to 8, in some embodiments of the present disclosure, openings 116 corresponding to cell exhaust ports 114 of the first battery cells 102 are provided on the partition plate 106, to allow gases that may be generated by the battery cells during operation to pass through. In addition, the vehicle battery pack 100 also includes a thermal insulation plate 112, which includes materials with heat insulation properties or coated with thermal insulation coatings, including but not limited to mica plate including silicates, rock wool plate, calcium silicate plate and other materials with good thermal insulation properties. In one example, the thermal insulation plate 112 is one of a plurality of thermal insulation plates. The thermal insulation plate 112 and the partition plate 106 jointly enclose an exhaust channel 118 connected to the openings 116. That is to say, the openings 116 are in fluid communication with the exhaust channel 118 or open towards the exhaust channel 118, so as to collect the gases that may be generated by the battery cells during operation into the exhaust channel 118 for discharge, thereby bettering thermal management performance and extending battery life. In some embodiments, as shown in FIGS. 4 and 6, the thermal insulation plate 112 can be located directly above the openings 116 and enclose with the partition plate 106 below to form the exhaust channel 118. The exhaust channel 118 can extend all the way to the lateral or longitudinal sides of the battery pack 100 to guide the gases that may be generated by the battery cells during operation to the two sides of the battery pack 100.

Continuing to refer to FIG. 5 and returning to FIG. 2, the vehicle battery pack 100 may also include an exhaust valve 122, which corresponds to an end of the exhaust channel 118. In one embodiment, the exhaust valve 122 may be located on a battery pack cover 120 or a battery tray 124. The exhaust valve 122 corresponding to the end of the exhaust channel 118 may include where the exhaust valve 122 is arranged near the end of each or some of the exhaust channels including the exhaust channel 118. Thus, the exhaust channel 118 is one of a plurality of exhaust channels. For example, one exhaust valve 122 can be arranged near the vertical upper end of each exhaust channel 118. This scheme can enable the gas that may be generated by the battery cells collected in the exhaust channel 118 during operation to be more quickly discharged to the outside of the vehicle battery pack 100 through the adjacent exhaust valve 122, addressing thermal management performance and extending battery life.

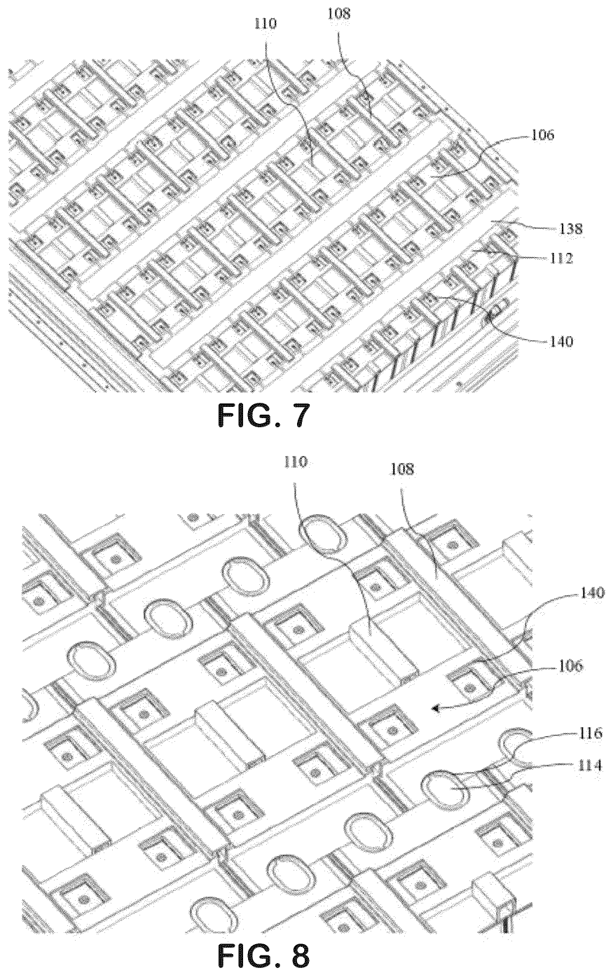

Referring to several embodiments shown in FIGS. 7 to 10, the partition plate 106 and the support members 108 are two independent components that can be connected to each other through connecting structures such as clamping, bonding, welding, bolt connection, etc. In another possible embodiment, the partition plate 106 and the support members 108 may be integrally formed component.

In one embodiment, the partition plate 106 comprises a plurality of partition plate units 132 connected together by adjacent support members 108. Connecting the partition plate 106 and the support members 108 can simplify the production process of both, facilitate the installation of the battery pack 100, and enable the free combination and installation of different numbers of battery cells according to the requirements of different battery capacities, allowing for flexible configuration. According to some embodiments of the present disclosure, the partition plate 106 and the support members 108 can be made of different materials. The partition plate 106 may include any electrically insulating material, such as but not limited to PP (polypropylene), PC (polycarbonate), etc. The support member 108 may include a metal material, such as but not limited to aluminum, steel, etc. Of course, in other embodiments, the partition plate 106 and the support member 108 can be made of the same materials, such as electrically insulating materials, such as but not limited to PP (polypropylene), PC (polycarbonate), etc.

It should be understood that, without departing from the technical essence of the present disclosure, the positional relationship between the partition plate 106 and the support members 108 may also differ from the embodiments shown in the accompanying drawings according to different battery pack structural requirements. In one embodiment, the partition plate and the support members are connected by connecting structures. In some possible embodiments, the partition plate 106 and the support members 108 may be spaced apart from each other and not connected together; and in further embodiments, the partition plate 106 may generally cover the first array 148 located below, while the support members 108 are located above the partition plate 106, i.e., the support members 108 overlap with the partition plate 106.

Continuing to refer to FIGS. 7 to 10, in further embodiments, the connecting structure between the partition plate 106 and the support members 108 may include a groove 134 and a protrusion 136 that match each other in shape. One of the groove 134 and the protrusion 136 may be located on one of the partition plate 106 and the support member 108, while the other of the groove 134 and the protrusion 136 may be located on the other of the partition plate 106 and the support member 108. The protrusion 136 can slide into the groove 134 and connect the partition plate 106 and the support member 108 together. In the illustrated embodiment, the groove 134 and the protrusion 136 may have a wedge-shaped or trapezoidal cross-section; and in other embodiments, the groove 134 and the protrusion 136 may also have cross-sections of other shapes, such as T-shaped, Y-shaped, etc. The assembly process of the partition plate 106 and the support member 108 is further simplified by the shape matching grooves 134 and protrusions 136. Each of the plurality of support members 108 may be symmetric and include the groove 134 on each side thereof. As such, one of the plurality of support members 108 may be coupled to two separate protrusions of two partition plates.

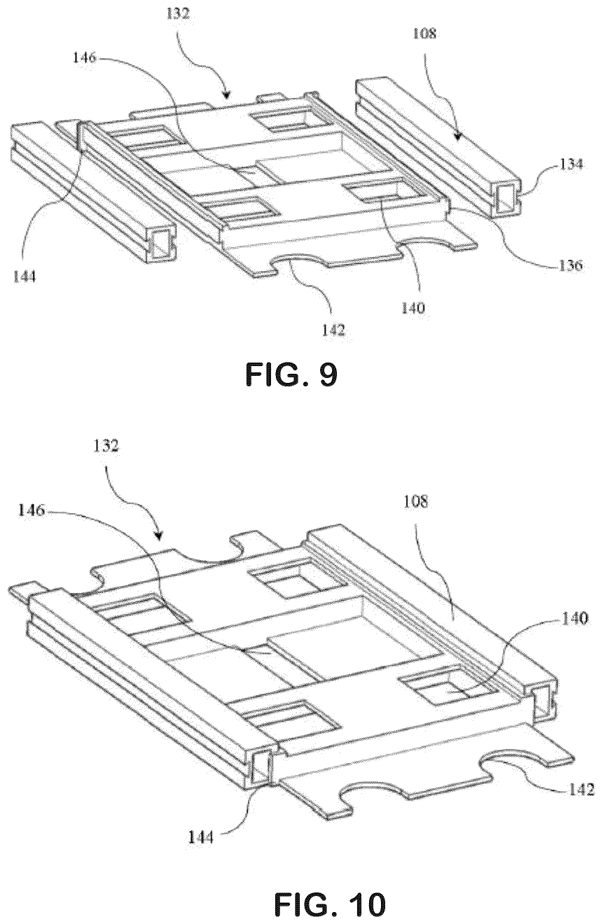

Referring to FIGS. 9 and 10, according to several embodiments of the present disclosure, a stopper 144 is provided on the groove 134 or the protrusion 136 to define the relative installation position of the two. The stopper 144 can be a catch or block placed in a predetermined position. This scheme can better define the relative installation position of the partition plate units 132 and the support member 108, so that they are accurately located at the set position.

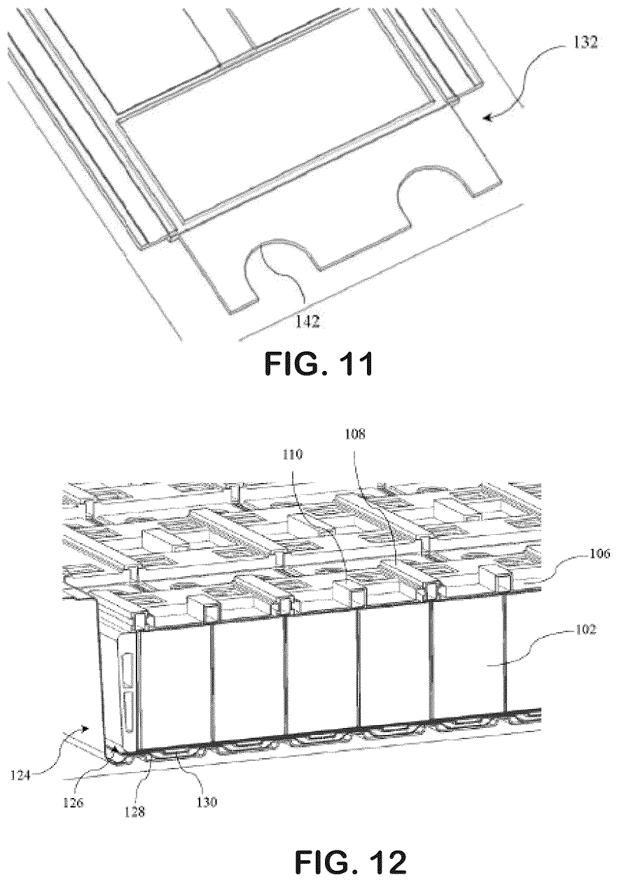

Referring to FIGS. 8 and 11, in some embodiments, each partition plate unit has two opposite edges adjacent to other partition plate units 132, and the opposite edges of each partition plate unit may have several arc-shaped notches 142. The arc-shaped notches 142 of adjacent partition plate units 132 are combined with each other to form the openings 116, corresponding to the cell exhaust ports 114 of the first battery cells 102. This structure facilitates the placement of the thermal insulation plate 112 above the adjacent portion of the partition plate units 132 to be better spaced relative to the support members 108.

Referring back to FIGS. 6 to 10, the vehicle battery pack 100 may further include a flexible sampling plate 138 for collecting information about each battery cell, and openings 140 are provided on the partition plate 106 for the flexible sampling plate 138 to sample the first battery cells 102. In the illustrated embodiment, each partition plate unit 132 has four openings 140, and the openings can have shapes such as rectangular, circular, polygonal, etc. This is only an example and not a limitation, and other numbers and shapes can also be used in other embodiments. The flexible sampling plate 138 can obtain real-time information such as temperature and voltage of each battery cell through the openings 140, and send it to a battery management system of the vehicle for real-time monitoring. In the illustrated embodiment, the flexible sampling plate 138 is located above the thermal insulation plate 112, but depending on the battery structure, the flexible sampling plate 138 can also be placed in other positions, such as on the side of the thermal insulation plate 112.

Referring to FIG. 12, in some embodiments of the present disclosure, the vehicle battery pack 100 further includes a battery tray 124 for supporting and accommodating the first array 148 and the second array 150, and a cooling plate 126 disposed between the first array 148 and the battery tray 124. Wherein, the battery tray 124 has a tray reinforcement groove 128 that is concave downwards. The tray reinforcement groove 128 is a groove-shaped recess formed on the battery tray 124 by processing techniques such as stamping and extrusion, which can increase the overall stiffness of the battery tray 124 and provide better support for the battery cells. The cooling plate 126 is used to accommodate the battery coolant and circulate it in the coolant channel 130 inside the cooling plate 126 for thermal management of the battery cells. The cooling plate 126 has a downward protruding coolant channel 130, such as a coiled fluid channel formed on the lower side of the cooling plate 126. The coolant channel 130 is located inside the battery tray reinforcement groove 128, for example, the coolant channel 130 occupies half to one-third of the volume of the battery tray reinforcement groove 128, and this is only an example and not a limitation. Placing the coolant channel 130 inside the tray reinforcement groove 128 can save vertical space and reduce compressing the coolant channel 130 and affecting the flow of the coolant.

Referring to FIGS. 10, 12, and 13, each partition plate unit of the plurality of partition plate units 132 may include a rectangular slot 146. In one example, the support members 108 are a plurality of first support members 108, wherein the vehicle battery pack 100 may further include a plurality of second support members 110, which are placed in the rectangular slots 146. The first support members 108 and the second support members 110 are arranged in a staggered manner, and each second battery cell 104 is supported on the critical portions 152 of the first battery cells 102 located below. In this embodiment, the staggered support members 108 and second support members 110 can provide more stable support force for the second array 150 located above. In one example, the critical portions 152 may correspond to interfaces between neighboring corners of neighboring first battery cells 102.

Those skilled in the art can understand that, according to specific structural requirements, the upper side of the second array 150 located above can also have a similar structure to the upper side of the first array 148 (such as the partition plate 106, the support member 108, the thermal insulation plate 112, etc.), or can have other feasible structures, such as not including the support member 108, etc. These schemes and variants do not deviate from the technical essence of the present disclosure.

In addition, the various components of the vehicle battery pack 100 described above and below may be made of materials, including but are not limited to, various types of aluminum alloys, magnesium alloys, various low-, medium-, and high-carbon steels, and any other metal/non-metal or synthetic/composite materials, plastics, etc. Furthermore, the various components of the vehicle battery pack 100 mentioned above can be manufactured through processing methods, such as but not limited to extrusion, stamping, casting, molding, 3D printing, etc. In addition, the joints or connections mentioned above or below can be achieved through various alternative methods, such as welding, bonding, crimping, threaded connection, integrated molding, etc. The welding can include but is not limited to inert gas shielded welding, laser welding, etc.

According to another aspect of the present disclosure, with reference to FIG. 1, there is also provided a vehicle 10 having the vehicle battery pack 100 as described in any of the above embodiments. It should be understood that all embodiments, features, and advantages described above for the battery pack 100 according to the present disclosure are equally applicable to the vehicle 10 according to the other aspect of the present disclosure, provided that they do not conflict with each other. That is to say, all embodiments and their variations described above can be directly applied and combined with them. For the sake of brevity in this disclosure, it will not be repeated here.

In summary, the present disclosure proposes a battery pack, the technical solution of which, compared to existing technologies, may further impact space utilization efficiency, simplify the overall structure, provide higher power based on limited space, and reduce production resources, thereby bettering user satisfaction. The battery pack includes a plurality of partition plates and a plurality of first support members. The plurality of partition plates and the plurality of first support members includes features for mating and interlocking with one another. For example, a first partition plate may include a plurality of protrusions, wherein a first protrusion engages with a groove of a first support member of the plurality of first support members. A second protrusion engages with a groove of a second support member of the plurality of first support members. A protrusion of a second partition plate may engage with a different groove of the first support member such that the second and first partition plates are separated along an edge via the first support member.

Partition plates of the plurality of partition plates may align along a different edge free of a first support member, wherein cutouts of the partition plates may join to form an opening of a plurality of openings. The opening may be coupled to an exhaust channel shaped by the plurality of partition plates and a plurality of thermal insulation plates.

The disclosure also provides support for a battery pack, comprising: a first array including a plurality of first battery cells arranged side by side, a second array including multiple second battery cells arranged side by side, a plurality of partition plates located between the first array and the second array and configured to electrically isolate the first array from the second array, and a plurality of support members located between the first array and the second array, wherein the second array is supported against the first array via the plurality of support members. In a first example of the system, the plurality of partition plates is coupled to the plurality of support members via a protrusion and a groove. In a second example of the system, optionally including the first example, each partition plate of the plurality of partition plates includes two protrusions and wherein each support member of the plurality of support members includes two grooves. In a third example of the system, optionally including one or both of the first and second examples, a stopper is provided on the groove or protrusion to limit relative installation position of the two. In a fourth example of the system, optionally including one or more or each of the first through third examples, a support member of the plurality of support members extends along a first direction and is supported neighboring edges of adjacent first battery cells extending along the first direction. In a fifth example of the system, optionally including one or more or each of the first through fourth examples, the system further comprises a plurality of thermal insulation plates, wherein a plurality of openings corresponding to cell exhaust ports of the first battery cells are shaped by a partition plate of the plurality of the plurality of partition plates, and the thermal insulation plate and the partition plate jointly enclose an exhaust channel connected to the openings. In a sixth example of the system, optionally including one or more or each of the first through fifth examples, the plurality of openings corresponding to cell exhaust ports of the plurality of first battery cells are shaped via cutouts of the plurality of partition plates. In a seventh example of the system, optionally including one or more or each of the first through sixth examples, the system further comprises an exhaust valve arranged at an end of the exhaust channel. In an eighth example of the system, optionally including one or more or each of the first through seventh examples, the system further comprises a flexible sampling plate for collecting information of each battery cell, wherein openings for the flexible sampling plate to sample the first battery cells is provided on the partition plate. In a ninth example of the system, optionally including one or more or each of the first through eighth examples, the system further comprises a battery tray and a cooling plate, wherein the battery tray has a tray reinforcement groove that is concave, and the cooling plate has a coolant channel that protrudes and is located inside the battery tray reinforcement groove.

The disclosure also provides support for a battery pack, comprising: a first array including a plurality of first battery cells, a second array including a plurality of second battery cells, a plurality of partition plates located between the first array and the second array, and a plurality of support members located between the first array and the second array, wherein each of the plurality of support members is arranged between neighboring partition plates of the plurality of partition plates. In a first example of the system, each of the plurality of support members is symmetric and comprises a plurality of grooves. In a second example of the system, optionally including the first example, each of the plurality of partition plates comprises a plurality of protrusions, wherein a first protrusion of a first plate of the plurality of partition plates is inserted into a groove of a first support member of the plurality of support members, and wherein a second protrusion of the first plate of the plurality of partition plates is inserted into a groove of a second support member of the plurality of support members. In a third example of the system, optionally including one or both of the first and second examples, each of the plurality of partition plates includes an arc-shaped cutout that shapes an opening with an adjacent partition plate of the plurality of partition plates. In a fourth example of the system, optionally including one or more or each of the first through third examples, the opening is arranged between the plurality of support members. In a fifth example of the system, optionally including one or more or each of the first through fourth examples, the opening is fluidly coupled to an exhaust channel. In a sixth example of the system, optionally including one or more or each of the first through fifth examples, an exhaust valve is arranged at an end of the exhaust channel.

The disclosure also provides support for a battery pack, comprising: a first array including a plurality of first battery cells, a second array including a plurality of second battery cells, a plurality of partition plates located between the first array and the second array, a plurality of support members located between the first array and the second array, each of the plurality of support members is arranged between neighboring partition plates of the plurality of partition plates, and a plurality of openings shaped by the plurality of partition plates, wherein the plurality of openings is fluidly coupled to an exhaust channel of the first array. In a first example of the system, the system further comprises: a plurality of thermal insulation plates, wherein the exhaust channel is shaped via the plurality of partition plates and the plurality of thermal insulation plates. In a second example of the system, optionally including the first example, the plurality of support members is a plurality of first support members, further comprising a plurality of second support members, each of the plurality of second support members arranged between neighboring first support members of the plurality of first support members.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-mentioned embodiments are possible examples of implementations of the present disclosure and are given only for the purpose of enabling those skilled in the art to clearly understand the principles of the invention. It should be understood by those skilled in the art that the above discussion to any embodiment is only illustrative, and is not intended to imply that the disclosed scope of the embodiments of the present disclosure (including claims) is limited to these examples; and under the overall concept of the invention, the technical features in the above embodiments or different embodiments can be combined with each other to produce many other changes in different aspects of embodiments of the invention that is not provided in detailed description for the sake of brevity. Therefore, any omission, modification, equivalent replacement, etc. made within the spirit and principle of the embodiment of the invention shall be included in the scope of protection claimed by the invention.

FIGS. 1-13 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 2-13 are shown approximately to scale. However, other relative dimensions may be used if desired.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery pack, comprising:
a first array including a plurality of first battery cells arranged side by side;
a second array including multiple second battery cells arranged side by side;
a plurality of partition plates located between the first array and the second array and configured to electrically isolate the first array from the second array; and
a plurality of support members located between the first array and the second array,
wherein the second array is supported against the first array via the plurality of support members.

2. The battery pack according to claim 1, wherein the plurality of partition plates is coupled to the plurality of support members via a protrusion and a groove.

3. The battery pack according to claim 2, wherein each partition plate of the plurality of partition plates includes two protrusions and wherein each support member of the plurality of support members includes two grooves.

4. The battery pack according to claim 3, wherein a stopper is provided on the groove or protrusion to limit relative installation position of the two.

5. The battery pack according to claim 1, wherein a support member of the plurality of support members extends along a first direction and is supported neighboring edges of adjacent first battery cells extending along the first direction.

6. The battery pack according to claim 1, further comprising a plurality of thermal insulation plates, wherein a plurality of openings corresponding to cell exhaust ports of the plurality of first battery cells are shaped by a partition plate of the plurality of the plurality of partition plates, and a thermal insulation plate of the plurality of thermal insulation plates and the partition plate jointly enclose an exhaust channel connected to the plurality of openings.

7. The battery pack according to claim 6, wherein the plurality of openings corresponding to cell exhaust ports of the plurality of first battery cells are shaped via cutouts of the plurality of partition plates.

8. The battery pack according to claim 6, further comprising an exhaust valve arranged at an end of the exhaust channel.

9. The battery pack according to claim 1, further comprising a flexible sampling plate for collecting information of each battery cell, wherein openings for the flexible sampling plate to sample the plurality of first battery cells is provided on a partition plate of the plurality of partition plates.

10. The battery pack according to claim 1, further comprising a battery tray and a cooling plate, wherein the battery tray has a tray reinforcement groove that is concave, and the cooling plate has a coolant channel that protrudes and is located inside the battery tray reinforcement groove.

11. A battery pack, comprising:
a first array including a plurality of first battery cells;
a second array including a plurality of second battery cells;
a plurality of partition plates located between the first array and the second array; and
a plurality of support members located between the first array and the second array, wherein each of the plurality of support members is arranged between neighboring partition plates of the plurality of partition plates.

12. The battery pack according to claim 11, wherein each of the plurality of support members is symmetric and comprises a plurality of grooves.

13. The battery pack according to claim 12, wherein each of the plurality of partition plates comprises a plurality of protrusions, wherein a first protrusion of a first plate of the plurality of partition plates is inserted into a groove of a first support member of the plurality of support members, and wherein a second protrusion of the first plate of the plurality of partition plates is inserted into a groove of a second support member of the plurality of support members.

14. The battery pack according to claim 11, wherein each of the plurality of partition plates includes an arc-shaped cutout that shapes an opening with an adjacent partition plate of the plurality of partition plates.

15. The battery pack according to claim 14, wherein the opening is arranged between the plurality of support members.

16. The battery pack according to claim 14, wherein the opening is fluidly coupled to an exhaust channel.

17. The battery pack according to claim 16, wherein an exhaust valve is arranged at an end of the exhaust channel.

18. A battery pack, comprising:
a first array including a plurality of first battery cells;
a second array including a plurality of second battery cells;
a plurality of partition plates located between the first array and the second array;
a plurality of support members located between the first array and the second array, each of the plurality of support members is arranged between neighboring partition plates of the plurality of partition plates; and
a plurality of openings shaped by the plurality of partition plates, wherein the plurality of openings is fluidly coupled to an exhaust channel of the first array.

19. The battery pack according to claim 18, further comprising a plurality of thermal insulation plates, wherein the exhaust channel is shaped via the plurality of partition plates and the plurality of thermal insulation plates.

20. The battery pack according to claim 18, wherein the plurality of support members is a plurality of first support members, further comprising a plurality of second support members, each of the plurality of second support members arranged between neighboring first support members of the plurality of first support members.
